(19) United States
(12) Patent Application Publication
(10) Pub. No.: US 2026/0210702 A1
(43) Pub. Date: Jul. 23, 2026

(54) DEVICE FOR THE INSPECTING A THREADED ELEMENT AND CORRESPONDING INSPECTION METHOD

(71) Applicant: VALLOUREC OIL AND GAS FRANCE, Aulnoye-Aymeries (FR)

(72) Inventors: Didier DAVID, Meudon (FR); Sébastien PETIT, Meudon (FR)

(73) Assignee: VALLOUREC OIL AND GAS FRANCE, Aulnoye-Aymeries (FR)

(21) Appl. No.: 19/136,661

(22) PCT Filed: Dec. 13, 2023
(86) PCT No.: PCT/EP2023/085710

§ 371 Date: Jun. 6, 2025

(30) Foreign Application Priority Data
Dec. 14, 2022 (FR) FR2213290

(51) Int. Cl. G01B 11/24

(52) U.S. Cl. CPC G01B 11/2425

(57) ABSTRACT

A dimensional measurement device for a threaded element that includes a first laser line sensor and a second laser line sensor having a second optical measurement direction, the second optical measurement direction forming a non-zero angle A with the first optical measurement direction. The first laser line sensor and the second laser line sensor are movably mounted on a framework and having at least one measurement path permitting the acquisition of geometric data of the threaded element, the path passing through a calibration gauge and being able to pass through a portion of the threaded element. The device includes an electronic unit arranged to construct a complete profile from a first partial profile from the first laser line sensor and from a second partial profile from the second laser line sensor and in dependence on at least one measurement carried out on the calibration gauge.

### TECHNICAL FIELD

The present invention relates to a device and a method for measurement of the screw thread form for a threaded element, more particularly for measurement of the thread form of elements such as a threaded joint for an oil well pipe, a carbon dioxide or hydrogen storage pipe, or a geothermal well pipe.

Measurement of the screw thread form determines a screw thread form profile in the axial screwing direction of the threaded element, and the screw thread elements are measured on the basis of the screw thread form profile. In the case, for example, of an oil well pipe screw thread, the screw thread elements comprise the following elements:
A threaded zone, which is a surface portion of a threaded element, said surface portion being delimited by a first screw thread end on one side and on the other side by a second end of that screw thread.

The threaded elements are equipped with threaded ends. These threaded ends are complementary, allowing a male tubular component (pin) and a female tubular component (box) to be connected together. There is therefore a male threaded end and a female threaded end. A threaded zone can comprise threads that are said to be perfect or threads that are said to be imperfect, an imperfect thread having a cross section corresponding to an incomplete cross section of a corresponding perfect thread, for example over a reduced height.

A screw thread is a group of the threads of a part, male or female, said group being created by a geometric profile which moves along a surface according to a helical movement.

A screw thread, when seen in a cross-sectional representation, comprises a succession of teeth or threads which are regularly spaced apart from one another. Thus, in a cross-sectional representation, a “tooth” is understood as being a crenellated portion extending from the base of a stabbing flank to the base of a loading flank, said stabbing flank and said loading flank being joined by a crest.

Within a threaded end, a male or female screw thread portion, when seen in transverse section, has a straight segment connecting mid-heights of loading thread flanks of consecutive threads, said segment forming an angle with the axis of the threaded end. If this angle is zero, the screw thread portion is said to be cylindrical. If the angle is non-zero, the screw thread portion is said to be conical. The angle can be expressed in degrees, radians, or as a percentage. The screw thread angle is equal to twice the angle formed between said straight segment and the axis of the threaded end, or the screw thread angle is equal to the angle at the apex of the cone formed by the straight segment as the generator rotating around the axis of the threaded end.

A screw thread can be cylindrical, that is to say have a generator that is parallel to the axis of the threaded end, or a screw thread can be conical, that is to say have a generator that forms a non-zero angle relative to the axis of the threaded end.

A thread comprises two flanks, the stabbing flank and the loading flank, a thread root and a thread crest.

The stabbing flanks are the thread surfaces that are capable of coming into contact when the screw threads of the male and female threaded components are engaged in one another. Consequently, they correspond to the flanks that face the free end of the tubular component in question.

The loading flanks are the thread surfaces that are capable of coming into contact when a threaded joint is subjected to axial tensile forces. Consequently, they correspond to the flanks that face the opposite side to the free end of the tubular component in question.

Positive or negative angle(s): Conventionally, within the context of the invention, the anti-trigonometric direction will be used, which is also the clockwise direction. Thus, a positive angle goes in the clockwise direction and, conversely, a negative angle goes in the anti-clockwise direction.

The machining of a tube to produce its thread involves the existence of a screw thread pitch. The notion of screw thread pitch must be understood in light of standard ISO 5408:2009, which concerns the definition of screw threads. The screw thread pitch corresponds to the axial distance, over one turn, between two successive points such as two successive crests or two successive roots of a screw thread, said distance being called “P”. The screw thread pitch must be controlled in order to permit screwing between the male screw thread and the corresponding female screw thread for the assembly and use of a joint.

### Technological Background

Conventional techniques for measuring the form of the screw thread of threaded elements are known, said techniques being based, for example, on tangential illumination of the screw thread and the capturing of an image by an optical sensor facing the light source in order to generate a two-dimensional image. There are variants relating to the orientation of the emission of light and the use of mirrors, but these methods have the disadvantage that they lack precision and are suitable for only a limited number of connection types. Indeed, as soon as a thread flank has a negative angle, it is impossible to project its complete profile, making direct measurement impossible.

In addition, even in a case where the screw thread is irradiated with parallel light in the tangential direction of the helix of the screw thread, the parallel light path is linear and not helical, and consequently the thread form profile captured by the parallel light is different from the actual profile, which is helical, with interference of the surfaces adjacent to a targeted section.

In addition, the device according to the invention is transportable.

### SUMMARY

The invention is based on the use of two optical sensors having different capture directions, and the possibility of combining the measurement data of the two sensors in order to reconstruct a measured screw thread form, thus allowing the cycle times for inspections to be reduced and a profile to be digitized, which profile can then be validated.

According to one embodiment, the invention provides a dimensional measurement device for a threaded element, said device comprising a framework, the framework comprising a first laser line sensor having a first optical measurement direction and a second laser line sensor having a second optical measurement direction, said second optical measurement direction forming a non-zero angle with the first optical measurement direction in a plane containing the first optical measurement direction, the first laser line sensor and the second laser line sensor being movably mounted on the framework and having at least one measurement path permitting the acquisition of geometric data of the threaded element, said path passing through a calibration gauge and being able to pass through a portion of the threaded element, the device comprising an encoder arranged to determine a position of the first laser line sensor and a position of the second laser line sensor along a main axis, and an electronic unit arranged to construct a first partial profile from the first laser line sensor and a second partial profile from the second laser line sensor, the electronic unit being arranged to construct a complete profile from the first partial profile and the second partial profile in dependence on the respective positions of the first laser line sensor and of the second laser line sensor and in dependence on at least one measurement carried out on the calibration gauge.

It is thus possible to propose a device which makes it possible to test and to measure an end of a threaded element with great accuracy, while at the same time being able to carry out measurements in poorly monitored environments, the positioning of the threaded element relative to the device being controlled mechanically and the sources of error associated with the positioning being compensated for in each measuring operation by calibration means integrated in the operation.

According to embodiments, such a device can have one or more of the following features.

According to one embodiment, the angle is between 30° and 70°, preferably between 40° and 60°. This allows a large variety of threads having a hook-type profile or having a dovetail-type profile to be measured.

According to one embodiment, the first laser line sensor and the second laser line sensor are mounted in translation on the framework. Thus, the path of the sensors relative to the part to be measured is simple and it is possible to compensate for a positioning offset error of the threaded element relative to the device.

According to one embodiment, the calibration gauge comprises surfaces that delimit predetermined reference lengths. This allows dimensional markers to be provided for the calibration process during a measuring operation.

According to one embodiment, the calibration gauge comprises a bearing face arranged to contact an end face of the threaded element to be measured. This allows positioning errors of the threaded element relative to the device to be minimized and the calibration procedure to be simplified.

According to one embodiment, the device comprises a positioning wedge disposed to be able to bear against thread crests of the threaded element. This allows the positioning of the device on the threaded element to be simplified and made more reliable.

According to one embodiment, the positioning wedge comprises a tapered insertion surface, which has a tapered insertion surface axis and is capable of being in contact with the thread crests of the threaded element. This allows the positioning wedge and the device to be adapted to threaded elements having a conical screw thread.

According to one aspect, the bearing face is perpendicular to the axis of the tapered insertion surface of the positioning wedge.

According to one embodiment, the calibration gauge comprises a stabbing flank reference surface, a loading flank reference surface, an axial length reference surface, and a radial length reference surface. This allows reference lengths to be defined for the calibration that correspond to the nominal characteristics of the threaded element to be measured, and allows the measurement accuracy to be improved.

According to one embodiment, the calibration gauge comprises a longitudinal reference extension defining a reference length Dr, and the electronic unit is arranged to determine a measurement path correction factor associated with the path of the first and second laser line sensors. This allows the measured values to be corrected in dependence on a positioning offset error of the threaded element relative to the device.

According to one embodiment, the electronic unit is arranged to compare a digital thread profile comprising minimum and maximum dimensions with the complete profile, and the electronic unit is configured to generate a result of conformity of the thread. This allows the user to be given a result of conformity of the threaded element.

According to one aspect, the electronic unit is arranged to carry out dimensional measurements of surfaces of the end of the threaded element.

The invention is also a method for the dimensional measurement of an end of a threaded element, said method comprising the steps of:
mounting the measurement device as above on the threaded element,
carrying out an acquisition of data by means of the first laser line sensor and the second laser line sensor on the measurement gauge,
determining measurement correction factors and storing them in a memory of the electronic unit,
carrying out a second acquisition of data on the end of the threaded element by means of the first laser line sensor and the second laser line sensor,
generating a first partial profile from a first data set resulting from the second acquisition of data by the first laser line sensor,
generating a second partial profile from a second data set resulting from the second acquisition of data by the second laser line sensor,
generating a complete profile from the first partial profile, the second partial provide and the measurement correction factors.

The method allows a threaded element to be measured and validated in respect of its dimensional characteristics by means of simple operations and with very great accuracy.

### BRIEF DESCRIPTION OF THE FIGURES

The invention will be better understood, and other aims, details, features and advantages thereof will become more clearly apparent, in the course of the following description of several particular embodiments of the invention, which are given solely by way of illustration and are not intended to be limiting, with reference to the accompanying drawings.

FIG. 1 is a perspective view of the device in a measuring position on a threaded element.

FIG. 2 is a perspective view of a calibration gauge according to the invention.

FIG. 3 is a perspective view of a positioning wedge according to the invention.

FIG. 4 is a schematic sectional view of an embodiment variant of the device of FIG. 1 within the context of a threaded element of the female type.

### DESCRIPTION OF THE EMBODIMENTS

The measurement device 1 according to the invention as visible in FIG. 1 comprises a framework 2 comprising a substantially rectangular table 10 on which there is mounted on a first side a handle 13, which an operator can operate in order to push the table toward a threaded element 6 or in order to pull the device away from the threaded element 6. The table 10 comprises on an opposite side to the first side at least one jack 12 connected to a positioning wedge 8. In the embodiment illustrated, the device comprises two jacks 12.

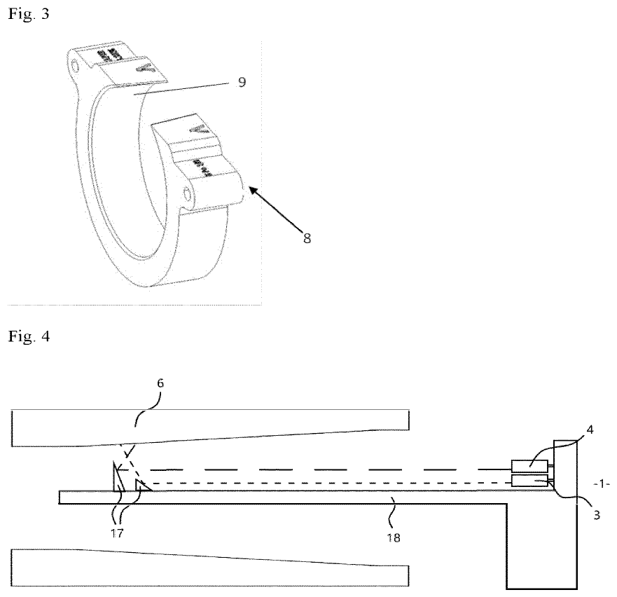

The positioning wedge 8, which is shown in isolation in FIG. 3, comprises an insertion surface 9 arranged to be in contact with thread crests of a threaded element 6. In the embodiment illustrated, the threaded element comprises a male screw thread with a taper. Consequently, the positioning wedge 8 comprises a tapered insertion surface 9 with a taper corresponding substantially to the taper of the screw thread, the tapered insertion surface 9 facing the inside so as to contact the crests of the male threads of the threaded element 6, said crests facing the outside. This tapered insertion surface 9 allows the device to be aligned with the axis of the screw thread. The tapered insertion surface 9 has a larger inside diameter and a smaller inside diameter such that the tapered insertion surface 9 positions itself on perfect threads of the threaded element 6. Indeed, the tapered insertion surface 9 must rest on perfect threads of the threaded element 6. It will be appreciated that the positioning wedge 8 is dimensioned in dependence on the connection model the screw thread of which is to be inspected, more particularly on the taper of the screw thread of the model of the connection. There is therefore a positioning wedge adapted to a conical connection, for example of type VAM©TOP 7-⅝, another positioning wedge adapted to a conical connection of type VAM©21 5-¾, or a cylindrical connection of type API, etc. A positioning wedge is therefore interchangeable with another wedge on the device according to the invention. A positioning wedge can also be adapted to several connection types.

The positioning wedge 8 is truncated so as to leave the threads visible in an orientation corresponding to a measurement path by dimensional sensors 3, 4.

The positioning wedge 8 allows the end of the threaded element 6, and a calibration gauge 5, to be placed in a depth of focus of the dimensional sensors such that the depth of focus of the lasers of the dimensional sensors is constant, whatever the diameter of the threaded element. This depth of focus can vary between 5 and 200 mm but is preferably between 5 and 50 mm. This makes it possible to avoid changing the positioning of the dimensional sensors in the direction (z) perpendicular to the table.

The device of FIG. 1 comprises two jacks or slide pins 12 connecting the positioning wedge 8 to the table 10.

When an operator positions the device according to the invention on one end of a threaded element 6, the positioning wedge 8 is brought around a screw thread of the threaded element 6, then the operator pushes the device toward the threaded element 6 with the aid of the handle 13, which facilitates gripping by the operator and the actions of positioning the device and putting it in place. The positioning wedge 8 is pushed onto the screw thread until the insertion surface 9, which comes to bear against thread crests of the screw thread of the threaded element 6, opposes any additional axial movement of the positioning wedge 8.

The operator can continue to push the device toward the threaded element 6 and the jacks or slide pins 12 such that the positioning cone is positioned on the perfect screw threads and until a bearing face 52 of the calibration gauge 5 is in contact with the end face of the threaded element 6.

More precisely, contact between the end of the threaded element 6 and the end of the table 10 is established between the end of the threaded element 6 and a calibration gauge 5 mounted on the table 10. The calibration gauge 5 is visible in detail in FIG. 3. The calibration gauge 5 is a part that has specifically been machined with great accuracy and some dimensions of which are perfectly known and recorded in a memory of an electronic unit of the device 1. The calibration gauge 5 comprises a transverse portion 51, which serves to position and fix the calibration gauge 5 on the table 10 on the one hand and, on the other hand, a planar front surface or bearing face 52 of which is to come into contact with an end of the threaded element 6. The calibration gauge 5 comprises a longitudinal portion 53, which has reference lengths, the dimensions of which are perfectly known. The reference lengths are delimited by surfaces. These lengths are therefore predetermined and serve as references for the device, and they are recorded in a memory of an electronic processing unit of the device. The reference surfaces are disposed to allow the device to correct the data acquired by the dimensional sensors 3, 4, said data being dependent on the positions and orientations of said dimensional sensors 3, 4 relative to the threaded element 6 and to the calibration gauge 5. The corrections are determined from measurements carried out by the dimensional sensors 3, 4 on the calibration gauge 5 and comparison of the measurements carried out with the values of the predetermined reference lengths. Correction factors can be calculated from this comparison. Thus, starting from first measurements carried out on the calibration gauge 5, the acquisition of data is corrected for the measurements carried out on the thread of the threaded element 5 with the correction factors so calculated.

The calibration gauge 5 is positioned on the measurement path of the dimensional sensors 3, 4 so as to allow calibration at each measurement operation on a threaded element 6.

The calibration gauge 5 comprises a bearing face 52 on its transverse portion 51 arranged to come into contact with an end face of the threaded element 6. The bearing face 52 is perpendicular to the axis of the tapered insertion surface 9 of the positioning wedge 8. In combination with the action of the positioning wedge 8 on the screw thread, the bearing of the bearing face 52 on the end face of the threaded element 6 allows the device to be locked on the threaded element 6 in order to carry out a measurement, and allows an orthogonal dimensional marker to be defined.

In particular, the calibration gauge 5 comprises a stabbing flank reference surface 54, a loading flank reference surface 55, an axial length reference surface 56, and a radial length reference surface 57. Thus, the stabbing flank reference surface 54 has an orientation substantially identical to the orientation of a stabbing flank surface of a thread of the threaded element 6 to be measured and, in an analogous manner, the loading flank reference surface 55 has an orientation substantially identical to the orientation of a loading flank surface of a thread of the threaded element 6. This allows the accuracy of measurement on the thread flanks to be improved. The axial length reference surface 56 is delimited by two surfaces detached from the axial length reference surface. The length of the axial length reference surface 56 corresponds to a reference axial distance and allows the accuracy of measurement of thread crests and roots to be improved. The radial length reference surface is realized by recesses perpendicular to the axial length reference surface 56.

The longitudinal portion 53 is situated in the continuation of the truncated portion of the positioning wedge 8. In other words, the longitudinal portion 53 is on the measurement path of the dimensional sensors 3, 4.

The device also comprises a longitudinal reference extension 11 on the calibration gauge 5. This longitudinal reference extension 11 is of known dimension, so as to define a reference distance Dr delimited on the one hand by a surface of the longitudinal reference extension 11, for example the surface facing the transverse portion 51, and a surface of the transverse portion 51. This allows a deviation of the path of the dimensional sensors 3, 4 relative to a theoretical path parallel to the axis of the threaded element to be identified through the measurements that are carried out.

The positioning wedge 8 and the calibration gauge 5 allow the device to be positioned repeatedly on the threaded element 6 and also so as to make the main axis of the threaded element 6 coincide as far as possible with a measurement axis of the device according to the invention, that is to say with a minimal deviation of the measurement axis relative to the main axis of the threaded element 6.

In the embodiment of FIG. 1, the two dimensional sensors 3, 4 are identical and are laser line sensors or laser profilers. A prototype has been constructed using GOCATOR 2510 sensors from LMI Technologies. The two dimensional sensors 3, 4 are mounted on a support, which is disposed to allow position and orientation adjustment on the three axes. Also, the dimensional sensors 3, 4 are mounted in translation so as to move in a direction corresponding substantially to the main direction or main axis (x), in order that the respective beams of the two laser profilers can pass through all the zones of interest of the end of the threaded element, namely the screw thread or screw threads, any functional surfaces and the other parts of the threaded end, or even the entirety of the end of the threaded element. The displacement along the axis of translation of the dimensional sensors 3, 4 is measured by a linear encoder.

The laser line sensors emit a laser beam centered on a direction of sight, so that the projection of the laser beam forms a line on a surface to be measured. The measurement of the laser is synchronized with the measurement of an optical encoder that determines a longitudinal position along the main axis (x). This allows a complete profile to be reconstructed from two plotted partial profiles digitized by the laser line sensors. The distances of the points of the projected line are evaluated by an internal image capture device of the camera type, the laser beam being emitted in a pulsed manner and the time of flight of the light beams being measured so as to determine a distance from the dimensional sensor. The direction of sight is substantially perpendicular to the face of the laser emitter.

An orthogonal marker attached to the measuring device and called the measurement marker (O, x, y, z) is defined. The main axis (x) is substantially aligned with a main axis x′ of the screw thread of the threaded element 6 to be measured. This alignment is obtained physically by placing the positioning wedge 8 on the threaded element. The secondary axis (y) is in a plane parallel to an upper surface of the calibration gauge 5, and the tertiary axis (z) is perpendicular to an upper surface of the calibration gauge 5.

The respective directions of sight of each of the respective optical measurement sensors or directions form, in a plane containing the main axis and the tertiary axis (O, x, z), an angle A between the first direction of sight and the second direction of sight which is between 30° and 70°. Preferably, the angle A is between 40° and 60°. With such an angle between the two directions, it is possible to measure the geometric data of the thread flanks whether the flanks have a negative angle or a positive angle. In particular, it is possible to carry out measurements on threads with a hook-type profile or with a dovetail-type profile. It is also possible to carry out measurements on variable pitch screw threads, which moreover are often associated with dovetail-type profiles.

The respective directions of sight of each of the dimensional sensors are opposed to one another, that is to say the direction of sight of the first sensor is opposite to the direction of sight of the second sensor in projection on the main axis (x).

The respective directions of sight can form a non-zero offset angle B in a plane containing the main axis (x) and the secondary axis (y). This angle is as close to zero as possible, but in reality it is of course imperfect. In order to improve the accuracy of measurement, this offset angle is compensated for by a calibration step in the measurement process, said calibration step involving carrying out a measurement step on the calibration gauge.

In addition, the displacement of the dimensional sensors 3, 4 does not take place strictly parallel to the main axis x′ of the threaded element to be measured but in a direction which can have a first angle of deviation ═ relative to the first axis (x) in the plane (O, x, y), a second angle of deviation β relative to the first axis (x) in the plane (O, x, z), and a third angle of deviation γ relative to the third axis (z) in the plane (O, y, z). The first measurement step on the calibration gauge 5 allows correction factors to be determined in dependence on the first angle of deviation α, the second angle of deviation β and the third angle of deviation γ.

The following step comprises the acquisition of a first set of measurements by the first dimensional sensor 4 and of a second set of measurements by the second dimensional sensor 5. The set of measurements relates to the screw thread of the threaded element, but it may relate to other functional surfaces of the threaded element, such as a stop surface or a sealing surface. These surfaces must meet very precise dimensional criteria because they have critical functionalities of ensuring an assembly torque and tightness with respect to liquids and/or gases in cooperation with a corresponding surface of a corresponding threaded element.

When a measurement is carried out by the dimensional measurement device 1 on a threaded element, the electronic unit is arranged to receive the measurements from the first dimensional sensor 3 and from a linear encoder, the output of which is representative of the positioning of the first dimensional sensor 3, the electronic unit is arranged to reconstruct a first partial profile of the threaded element under investigation. In an analogous manner, the electronic unit is arranged to receive the measurements from the second dimensional sensor 4 and from the linear encoder, the output of which is representative of the positioning of the second dimensional sensor 4, the electronic unit is arranged to reconstruct a second partial profile of the threaded element under investigation.

During the measurement on the threaded element, the first and second dimensional sensors 3, 4 carry out measurements on the threaded element and also on the calibration gauge 5. The electronic unit is arranged to record the measurements carried out on the calibration gauge 5 and to determine from the measurements which have been carried out measured values on the surfaces delimiting the reference lengths, including reference values of a stabbing flank reference surface 54, a loading flank reference surface 55, an axial length reference surface 56, and a radial length reference surface 57, and to determine correction factors by comparison of the measurements carried out on these surfaces with the values of the actual lengths of the reference surfaces.

During the measurement on the threaded element, the first and second dimensional sensors 3, 4 also carry out measurements on the longitudinal reference extension 11 and determine a measured reference length value Dr′. By comparing the measured reference length value Dr′ with the reference length Dr, the electronic unit is arranged to determine a measurement path correction factor associated with the path of the first and second dimensional sensors 3, 4. This factor allows a difference between the main axis of the threaded element and the axis of displacement of the dimensional sensors 3, 4 to be compensated for.

The displacement of the dimensional sensors 3, 4 can be effected at a variable speed, for example at a first, lower displacement speed in order to make a more dense acquisition of measurement points, and at a second displacement speed that is higher than the first displacement speed where it is not necessary to have a large number of measurement points of the surface. It is advantageous to have a slower speed, and therefore more measurement points, on functional surfaces such as a stop surface or a sealing surface, or on surfaces that are very inclined relative to the main axis (x).

The electronic unit is arranged to construct a complete profile of the threaded element by combining the first partial profile and the second partial profile, after the measured data have been processed taking account of the correction factors.

The electronic unit is arranged to superpose the complete profile with a digitized profile comprising two profile traces, a maximum profile and a minimum profile, delimiting a profile envelope. The electronic unit is arranged to display a compliant result to the user when the complete profile is situated entirely within the envelope, or to display a non-compliant result if the complete profile is not entirely within the envelope.

The electronic unit is arranged to allow the complete profile to be compared with reference geometric forms.

The first partial profile can comprise measurement points on the thread crests, the thread root and one of the flanks, for example the stabbing flanks, owing to the orientation of the first laser line sensor relative to the screw thread, while the second partial profile can comprise measurement points on the thread crests, the thread root and the other flank and, relative to the example given, loading flanks. Thus, the first partial profile and the second partial profile can have measurement points on common parts of the measured surfaces and measurement points on different parts of the measured surfaces, owing to the different and opposite orientations of the two laser line sensors. Combining the first partial profile and the second partial profile will then reveal groups of complementary points and groups of superposed points. The complete profile, as a combination of the two partial profiles corrected after the data have been processed, comprises measurement points on all the surfaces under investigation.

Thus, the device according to the invention makes it possible to implement a method for the dimensional measurement of an end of a threaded element 1, said method comprising the following successive steps.

Firstly, the device 1 is brought onto the threaded element 6 and is mounted thereon such that the positioning wedge 8 is placed on the screw thread, more precisely on thread crests of the screw thread of the threaded element 6, and more precisely on perfect thread crests. This placing is effected by axial introduction of the positioning wedge 8 around the end of the threaded element 6 and until the positioning wedge 8 opposes any additional displacement, and then the framework is pushed by an operator, with the aid of the handle 13, toward the end of the threaded element so that the jacks 12 are compressed and until the stop face 52 of the calibration gauge 5 is in contact with an end face of the threaded element 6. The measurement device 1 is thus positioned so as to minimize any offset between the axis of the threaded element 6 and a main axis x of a marker attached to the measurement device.

Secondly, a data acquisition phase is initiated, during which the dimensional sensors 3, 4 will travel along a straight path which passes through the measurement gauge and the surfaces of the threaded element 6 that are to be measured, said surfaces comprising at least one screw thread, and optionally a stop surface, and optionally also a sealing surface.

A data acquisition step is carried out on the measurement gauge 5. Then, a step of determining measurement correction factors is carried out by comparing the predetermined values corresponding to the actual values of the dimensions of certain surfaces of the calibration gauge 5 with the values measured on said surfaces by the dimensional sensors 3, 4.

A data acquisition step is carried out on the surface or surfaces of the threaded element that is/are to be measured, said surface or surfaces comprising at least one screw thread, and optionally a stop surface, and optionally also a sealing surface, so as to obtain a first partial profile resulting from the measurements carried out by the first dimensional sensor 3 and from the linear encoder, and to obtain a second partial profile resulting from the measurements carried out by the second dimensional sensor 4.

The partial profiles are then combined, after corrections have been applied with the measurement correction factors, to form a complete profile.

The complete profile can then be subjected to a filtering or smoothing operation.

The resulting complete profile is then compared with a digital profile representing an envelope of minimum and maximum dimensions of the screw thread profile, and a result of conformity of the screw thread is obtained, said result being positive if the complete profile is contained entirely within the envelope defined by the digitized profile, or negative in the opposite case.

Finally, dimensional measurements can be carried out on the complete profile, such as, without implying any limitation: determination of radii of curvature (by circle inscription), direct linear measurement between points of the profile.

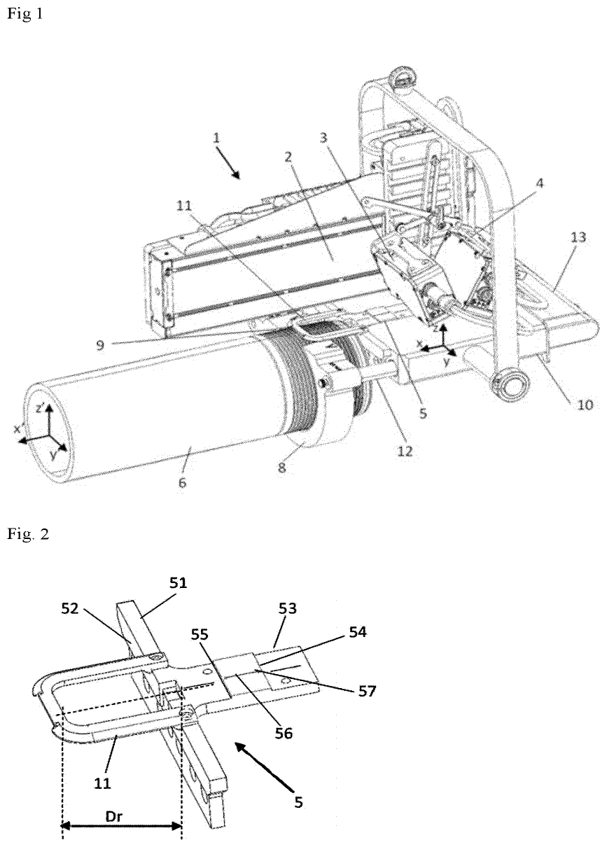

FIG. 4 illustrates, schematically, an embodiment variant of the device of FIG. 1 within the context of a threaded element of the female type, that is to say having a screw thread on an inner surface of the threaded element. In FIG. 4, elements that are identical to or perform the same function as those described above in relation to FIGS. 1 to 3 bear the same reference signs.

Within the context of a large-dimension threaded element 6 of the female type (not shown), the measurement device 1 is analogous to the measurement device 1 described above, with an orientation of the dimensional sensors 3, 4 that is adapted to emit a laser beam in the direction of the screw thread of the threaded element 6, and optionally of a stop surface, and optionally also of a sealing surface. A large-dimension threaded element 6 is understood as being a threaded element that allows the dimensional sensors 3, 4 to be inserted into said threaded element 6 with a minimal distance between the dimensional sensors 3, 4 and the surface or surfaces of the threaded element 6 that is/are to be inspected. Typically, the distance between the dimensional sensors 3, 4 and the surface or surfaces to be inspected must be greater than the start of the measurement range of said dimensional sensors 3, 4.

However, if the inside diameter of the threaded element 6 does not allow the dimensional sensors 3, 4 to be inserted with a distance between said dimensional sensors 3, 4 and the surface or surfaces to be inspected that is greater than the measurement range start distance of said dimensional sensors 3, 4, the measurement device 1 comprises mirrors 17 (see FIG. 4) for orienting the laser beams emitted by the dimensional sensors 3, 4 in the direction of the surface or surfaces on the threaded element 6 that is/are to be inspected. The dimensional sensors 3, 4 are then mounted on the framework 2 so as to emit their laser beam in the direction of the mirrors 17, said mirrors 17 being mounted in a movable and orientable manner on the measurement device 1 in order to redirect the laser beams.

The measurement device 1 comprises a displacement and guide means for the mirrors 17, in the embodiment illustrated in FIG. 4 a guide rail 18. This displacement and guide means is inserted into the threaded element 6 when the measurement device 1 is being positioned on the threaded element 6, typically, and analogously to the positioning of the measurement device described above in relation to FIGS. 1 to 3, when the tapered insertion surface of the positioning wedge and the bearing face bear against the crests of the perfect threads and the end face of the threaded element 6, respectively.

The mirrors 17 are mounted on the guide rail 18 so as to be able to move along said guide rail 18, for example by means of an ad hoc motor. The position of the mirrors 17 is further controlled analogously to the control of the position of the dimensional sensors 3, 4 of FIGS. 1 to 3, for example by means of a linear encoder. The dimensional sensors 3, 4 are oriented so as to emit a laser beam in the direction of a respective mirror 17. This laser beam is then reflected by said mirror 17 in order to strike the surface or surfaces to be inspected, for example the gauge, the screw thread of the threaded element 6, a stop surface and/or a sealing surface.

Advantageously, the mirrors 17 further have an orientation that is configurable, for example by means of an orientable mirror support or a pivot link between the mirror 17 and the guide rail 18. Thus, the mirrors 17 are capable of moving and changing orientation along the guide rail 18. This change of orientation could also be obtained by replacing the mirror 17 on the guide rail 18 with a mirror having the desired orientation.

The orientation of the mirrors 17 allows the laser beams emitted by the dimensional sensors to be directed according to the desired orientation. In other words, adjustment of the orientation of the dimensional sensors 3, 4 in the embodiment illustrated in FIG. 1 is here replaced by adjustment of the orientation of the mirrors 17, this orientation of the mirrors 17 defining the optical measurement directions of the dimensional sensors. It is thus possible, by virtue of the respective orientation of the mirrors 17 and of the dimensional sensors 3, 4, to define optical measurement directions that form an angle between the first direction of sight and the second direction of sight, for example an angle of between 30° and 70°, and preferably between 40° and 60°.

In another embodiment, the orientation of the mirrors 17 is fixed, for example at 45° relative to the longitudinal axis of the threaded element 6, but the orientation of the dimensional sensors 3, 4 can be modified in order to strike the mirrors 17 at different angles, thus allowing the corresponding directions of sight to be oriented. In addition, the mirrors 17 can have different shapes, for example mirrors 17 that are planar, have multiple faces, are curved or the like, in order to permit different orientations of the directions of sight. It is, for example, possible to have two mirrors 17, one for each dimensional sensor 3, 4, or, by contrast, a single mirror 17 with a particular shape that allows the direction of sight to be oriented in dependence on the orientation of the dimensional sensor 3 or 4.

Analogously to the embodiment illustrated in FIG. 1, the calibration gauge 5 is positioned on the measurement path of the dimensional sensors 3, 4, said measurement path being defined by the mirrors 17, so as to permit calibration at each measuring operation on a threaded element 6.

1. A dimensional measurement device for a threaded element 1, said device comprising a framework, the framework comprising a first laser line sensor having a first optical measurement direction and a second laser line sensor having a second optical measurement direction, said second optical measurement direction forming a non-zero angle A with the first optical measurement direction in a plane containing the first optical measurement direction, the first laser line sensor and the second laser line sensor being movably mounted on the framework and having at least one measurement path permitting the acquisition of geometric data of the threaded element, said path passing through a calibration gauge and being able to pass through a portion of the threaded element, the device comprising an encoder arranged to determine a position of the first laser line sensor and a position of the second laser line sensor along a main axis (x), and an electronic unit arranged to construct a first partial profile from the first laser line sensor and a second partial profile from the second laser line sensor, the electronic unit being arranged to construct a complete profile from the first partial profile and the second partial profile in dependence on the respective positions of the first laser line sensor and of the second laser line sensor and in dependence on at least one measurement carried out on the calibration gauge.

2. The measurement device as claimed in claim 1, wherein said angle A is between 30° and 70°,

3. The measurement device as claimed in claim 1, wherein the first laser line sensor and the laser line sensor are mounted in translation on the framework.

4. The measurement device as claimed in claim 1, wherein the calibration gauge comprises surfaces that delimit predetermined reference lengths.

5. The measurement device as claimed in claim 1, wherein the calibration gauge comprises a bearing face arranged to contact an end face of the threaded element to be measured.

6. The measurement device as claimed in claim 1, comprising a positioning wedge disposed to be able to bear against thread crests of the threaded element.

7. The measurement device as claimed in claim 6, wherein the positioning wedge comprises a tapered insertion surface, which has a tapered insertion surface axis and is capable of being in contact with the thread crests of the threaded element.

8. The measurement device as claimed in claim 5, comprising a positioning wedge disposed to be able to bear against thread crests of the threaded element,
wherein the positioning wedge comprises a tapered insertion surface, which has a tapered insertion surface axis and is capable of being in contact with the thread crests of the threaded element,
wherein said bearing face is perpendicular to the axis of the tapered insertion surface of the positioning wedge.

9. The measurement device as claimed in claim 1, wherein the calibration gauge comprises a stabbing flank reference surface, a loading flank reference surface, an axial length reference surface, and a radial length reference surface.

10. The measurement device as claimed in claim 1, wherein the calibration gauge comprises a longitudinal reference extension defining a reference length Dr, and the electronic unit is arranged to determine a measurement path correction factor associated with the path of the first and second laser line sensors.

11. The measurement device as claimed in claim 1, wherein the electronic unit is arranged to compare a digital thread profile comprising minimum and maximum dimensions with the complete profile, and the electronic unit is configured to generate a result of conformity of the thread.

12. The measurement device as claimed in claim 1, wherein the electronic unit is arranged to carry out dimensional measurements of surfaces of the end of the threaded element.

13. A method for the dimensional measurement of an end of a threaded element, said method comprising the steps of:
mounting the measurement device as claimed in one of the preceding claims on the threaded element,
carrying out an acquisition of data by means of the first laser line sensor and the second laser line sensor on the measurement gauge,
determining measurement correction factors and storing them in a memory of the electronic unit,
carrying out a second acquisition of data on the end of the threaded element by means of the first laser line sensor and the second laser line sensor,
generating a first partial profile from a first data set resulting from the second acquisition of data by the first laser line sensor,
generating a second partial profile from a second data set resulting from the second acquisition of data by the second laser line sensor,
generating a complete profile from the first partial profile, the second partial profile and the measurement correction factors.

14. The measurement device as claimed in claim 1, wherein said angle A is between 40° and 60°.
